(19) United States
(12) Patent Application Publication
(10) Pub. No.: US 2014/0324424 A1
(43) Pub. Date: Oct. 30, 2014

(54) METHOD FOR PROVIDING A SUPPLEMENTARY VOICE RECOGNITION SERVICE AND APPARATUS APPLIED TO SAME

(71) Applicant: Yongjin Kim, Seoul (KR)

(72) Inventor: Yongjin Kim, Seoul (KR)

(21) Appl. No.: 14/360,348

(22) PCT Filed: Nov. 15, 2012
(86) PCT No.: PCT/KR2012/009639

§ 371 Date: May 23, 2014

(30) Foreign Application Priority Data
Nov. 23, 2011 (KR) 10-2011-0123192

(51) Int. Cl. G10L 15/26; G10L 17/22

(52) U.S. Cl. CPC G10L 15/26; G10L 17/22
USPC 704/235

(57) ABSTRACT

Disclosed are a method of providing a voice recognition supplementary service and an apparatus applied to the same. The method includes: generating voice information corresponding to a designated step by a provision of a voice recognition service to a terminal device and text information corresponding to the voice information; providing the voice information generated according to the designated step to the terminal device; and transmitting the generated text information to the terminal device simultaneously with the provision of the voice information and continuously displaying the transmitted text information such that the text information is synchronized with the corresponding voice information provided to the terminal device.

### TECHNICAL FIELD

The present disclosure relates to a method of providing a voice recognition supplementary service, and more particularly to, a method of providing a voice recognition supplementary service and an apparatus applied to the same for improving a keyword recognition rate by inducing a user to input a voice through the provision of a screen containing a suggested word pertaining to a service and available functions expected to be used in each situation in connection with a voice recognition service, and improving understanding and convenience of the service by sequentially providing both a voice guide provided to the user and a keyword input by the user through a chatting window.

### BACKGROUND ART

In general, a voice recognition service provided by a call center refers to a service that finds desired information based on a keyword requested by a customer through a voice. The service provides a suggested word to a user through a voice and receives a voice of the user based on the provided suggested word, so as to provide a corresponding service through keyword recognition.

However, in a conventional voice recognition service, when the customer does not accurately speak the keyword pertaining to a service which the customer desires to receive, the use of the service may not be smooth.

That is, the conventional voice recognition service provides a suggested word through a voice, but the number of words which can be provided through the voice is limited due to a time restriction, and accordingly the user may not accurately recognize the keyword which the user should say to use the service and thus may give up using the service.

### DISCLOSURE

### Technical Problem

The present disclosure has been made to solve the above problem and an aspect of the present disclosure is to induce a user to input a voice through the provision of a screen containing a suggested word and available functions of services expected to be used in respective situations in connection with a voice recognition service by providing a screen service device and a method of operating the same for transmitting a driving message to provide the voice recognition service to a terminal device, driving a service application installed within the terminal device, obtaining text information corresponding to voice information transmitted to the terminal device according to each designated step by the provision of the voice recognition service, configuring screen content including the obtained text information according to a format designated to the service application, providing the screen content, configured according to each designated step to the terminal device, and continuously displaying the text information included in the screen content such that the text information is synchronized with the corresponding voice information transmitted to the terminal device.

The present disclosure has been made to solve the above problem and another aspect of the present disclosure is to induce a user to input a voice through the provision of a screen containing a suggested word and available functions of services expected to be used in respective situations in connection with a voice recognition service by providing a voice recognition device and a method of operating the same for generating voice information corresponding to a designated step by the provision of the voice recognition service and text information corresponding to the voice information to the terminal device, transmitting the generated text information to the terminal device simultaneously with the provision of the voice information, and continuously displaying the transmitted text information such that the text information is synchronized with the corresponding voice information transmitted to the terminal device.

The present disclosure has been made to solve the above problem and another aspect of the present disclosure is to induce a user to input a voice through the provision of a screen containing a suggested word and available functions of services expected to be used in respective situations in connection with a voice recognition service by providing a terminal device and a method of operating the same for receiving voice information corresponding to a designated step by a voice recognition service connection, obtaining screen content including text information synchronized with the voice information received according to each designated step, and displaying the text information included in the screen content according to the provision of the voice information.

### Technical Solution

In accordance with an aspect of the present disclosure, a screen service device is provided. The screen service device includes: a terminal driver for transmitting a driving message to provide a voice recognition service to a terminal device and driving a service application installed within the terminal device; a content configuration unit for obtaining text information corresponding to voice information transmitted to the terminal device according to each designated step by the provision of the voice recognition service and configuring screen content including the obtained text information according to a format designated to the service application; and a content provider for providing the screen content configured according to said each designated step to the terminal device and continuously displaying text information included in the screen content such that the text information is synchronized with corresponding voice information transmitted to the terminal device.

The content configuration unit may obtain at least one of first text information corresponding to voice information transmitted to the terminal device to provide information on the voice recognition service and second text information corresponding to a voice suggested word transmitted to the terminal device to induce a voice input of a user and configure the screen content.

When a voice of the user based on the voice suggested word is transmitted, the content configuration unit may obtain third text information which is keyword information corresponding to a voice recognition result and configure the screen content including the obtained third text information.

The content configuration unit may obtain fourth text information corresponding to a voice query word transmitted to the terminal device to identify a recognition error of the keyword information and configure the screen content including the obtained fourth text information.

The content configuration unit may obtain fifth text information corresponding to a voice guide of a particular content extracted based on the keyword information and transmitted to the terminal device and configure the screen content including the obtained fifth text information.

When the recognition error of the keyword information is identified, the content configuration unit may obtain sixth text information corresponding to a voice suggested word transmitted to the terminal device to induce the user to make a voice re-input and configure the screen content including the obtained sixth text information.

In accordance with another aspect of the present disclosure, a voice recognition device is provided. The voice recognition device includes: an information processor for generating voice information corresponding to each designated step by a provision of a voice recognition service to a terminal device, providing the generated voice information to the terminal device, and generating text information corresponding to the generated voice information; and an information transmitter for transmitting the text information generated according to said each designated step to the terminal device and continuously displaying the transmitted text information such that the text information is synchronized with the corresponding voice information provided to the terminal device.

The information processor may simultaneously generate text information and voice information corresponding to at least one of a voice guide providing information on the voice recognition service and a voice suggested word for inducing a voice input of a user.

When a voice of a user based on the voice suggested word is transmitted from the terminal device, the information processor may extract keyword information corresponding to a voice recognition result and generates text information corresponding to the extracted keyword information.

The information processor may simultaneously generate the voice information and the text information corresponding to a voice query word for identifying a recognition error of the extracted keyword information.

When the recognition error of the extracted keyword information is identified, the information processor may simultaneously generate voice information and text information corresponding to a voice suggested word for inducing the user to make a re-input.

The information processor may obtain a particular content based on the extracted keyword information and generate voice information and text information corresponding to the obtained particular content.

When a transmission time point when the text information is transmitted to the terminal device is identified, the information processor may provide the voice information to the terminal device according to the identified transmission time point or transmit a separate request for reproducing the voice information pre-provided.

In accordance with another aspect of the present disclosure, a terminal device is provided. The terminal device includes: a voice processor for receiving voice information corresponding to a designated step by a connection of a voice recognition service; and a screen processor for obtaining screen content including text information synchronized with the voice information received according to each designated step and displaying the text information included in the screen content according to the reception of the voice information.

When new text information is obtained according to the designated step, the screen processor may add and display the new text information while maintaining the previously displayed text information.

In accordance with another aspect of the present disclosure, a method of operating a screen service device is provided. The method includes: driving a service application installed within a terminal device by transmitting a driving message to provide a voice recognition service to the terminal device and; obtaining text information corresponding to voice information transmitted to the terminal device according to each designated step by the provision of the voice recognition service; configuring screen content including the obtained text information according to a format designated to the service application; and providing the screen content configured according to said each designated step to the terminal device and continuously displaying the text information included in the content screen such that the text information is synchronized with the corresponding voice information transmitted to the terminal device.

The configuring of the screen content may include configuring the screen content including at least one of first text information corresponding to voice information transmitted to the terminal device to provide information on the voice recognition service and second text information corresponding to a voice suggested word transmitted to the terminal device to induce a voice input of a user.

When a voice of the user based on the voice suggested word is transmitted, the configuring of the screen content may include configuring the screen content including third text information which is keyword information corresponding to a voice recognition result.

The configuring of the screen content may include configuring the screen content including fourth text information corresponding to a voice query word transmitted to the terminal device to identify a recognition error of the keyword information.

The configuring of the screen content may include configuring the screen content including fifth text information corresponding to a voice guide of a particular content extracted based on the keyword information and transmitted to the terminal device.

When the recognition error of the keyword information is identified, the configuring of the screen content may include configuring the screen content including sixth text information corresponding to a voice suggested word transmitted to the terminal device to induce the user to make a voice re-input.

In accordance with another aspect of the present disclosure, a method of operating a voice recognition device is provided. The method includes: generating voice information corresponding to a designated step by a provision of a voice recognition service to a terminal device and text information corresponding to the voice information; providing the voice information generated according to the designated step to the terminal device; and transmitting the generated text information to the terminal device simultaneously with the provision of the voice information and continuously displaying the transmitted text information such that the text information is synchronized with the corresponding voice information provided to the terminal device.

The generating of the voice information may include simultaneously generating text information and voice information corresponding to at least one of a voice guide for providing information on the voice recognition service and a voice suggested word for inducing a voice input of a user.

When a voice of a user based on the voice suggested word is transmitted from the terminal device, the generating of the voice information may include: extracting keyword information corresponding to a voice recognition result; and generating text information corresponding to the extracted keyword information.

The generating of the voice information may include simultaneously generating the voice information and the text information corresponding to a voice query word for identifying a recognition error of the extracted keyword information.

When the recognition error of the extracted keyword information is identified, the generating of the voice information may include simultaneously generating voice information and text information corresponding to a voice suggested word for inducing the user to make a re-input.

The generating of the voice information may include obtaining a particular content based on the extracted keyword information and generating voice information and text information corresponding to the obtained particular content.

In accordance with another aspect of the present disclosure, a method of operating a terminal device is provided. The method includes: receiving voice information corresponding to a designated step by a connection of a voice recognition service; obtaining screen content including text information synchronized with voice information received according to each designated step; and displaying the text information included in the screen content according to the reception of the voice information.

When new text information is obtained according to the designated step, the displaying of the text information comprises adding and displaying the new text information while maintaining the previously displayed text information.

The providing of the voice information may include: identifying a transmission time point when the text information is transmitted to the terminal device; and providing the voice information according to the identified transmission time point to the terminal device to make a request for reproducing the voice information or transmitting a separate request for reproducing the voice information pre-provided.

In accordance with another aspect of the present disclosure, a computer-readable recording medium including a command is provided. The command executes the steps of: receiving voice information corresponding to a designated step by a connection of a voice recognition service; obtaining screen content including text information synchronized with voice information received according to each designated step; and displaying the text information included in the screen content according to the reception of the voice information.

When new text information is obtained according to the designated step, the displaying of the text information may include adding and displaying the new text information while maintaining the previously displayed text information.

### Advantageous Effects

According to a voice recognition supplementary service providing method and an apparatus applied to the same according to the present disclosure, when a voice recognition service is provided, it is possible to maximally use a service function which cannot be provided through a voice alone by providing a suggested word corresponding to the service expected to be used in each situation through a screen rather than a voice, and also providing available functions through the screen.

Further, it is possible to improve the keyword recognition rate of the input voice by providing the screen containing the suggested words for the service and available functions and inducing a voice input of the user through the screen recognition.

In addition, both a voice guide provided to the user and the keyword input by the user are provided in a chatting window scheme and thus the user can quickly use the service while viewing only the screen without depending on a voice guide, thereby improving understanding and convenience according to the service use.

### BRIEF DESCRIPTION OF THE DRAWINGS

FIG. 1 schematically illustrates a configuration of a voice recognition supplementary service providing system according to an embodiment of the present disclosure;

FIG. 2 schematically illustrates a terminal device according to an embodiment of the present disclosure;

FIG. 3 schematically illustrates a voice recognition device according to an embodiment of the present disclosure;

FIG. 4 schematically illustrates a screen service device according to an embodiment of the present disclosure;

FIGS. 5 and 6 illustrate a voice recognition supplementary service providing screen according to an embodiment of the present disclosure;

FIG. 7 is a flowchart describing a method of operating a voice recognition supplementary service providing system according to an embodiment of the present disclosure;

FIGS. 8 to 10 are flowcharts describing synchronization of voice information and text information according to an embodiment of the present disclosure;

FIG. 11 is a flowchart describing an operation method of a terminal device according to an embodiment of the present disclosure;

FIG. 12 is a flowchart describing an operation method of a voice recognition device according to an embodiment of the present disclosure; and

FIG. 13 is a flowchart describing an operation method of a screen service device according to an embodiment of the present disclosure.

### BEST MODE

### Mode for Invention

Hereinafter, exemplary embodiments of the present disclosure will be described with reference to the accompanying drawings.

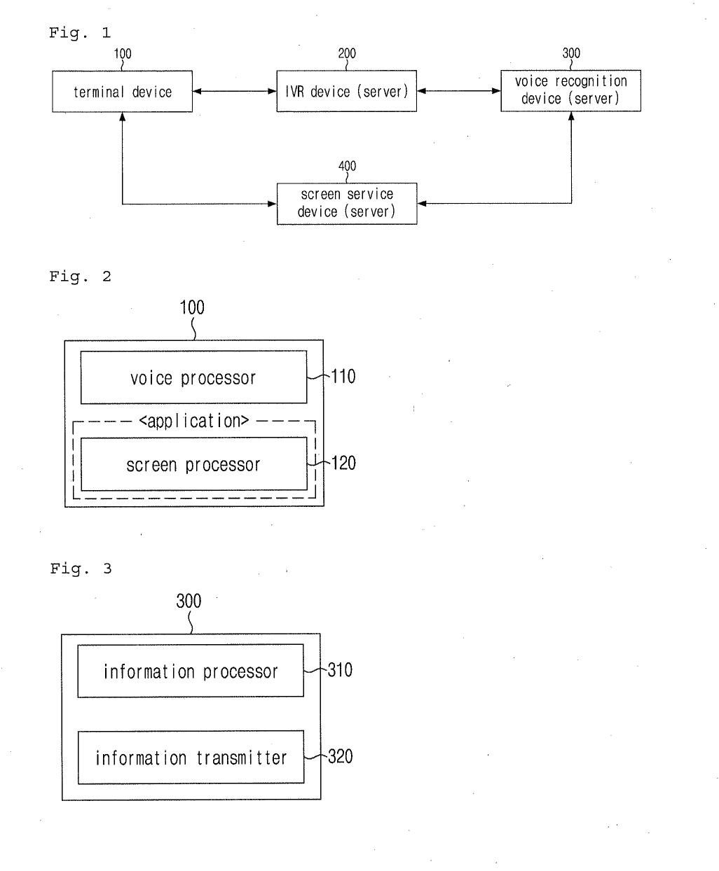

FIG. 1 schematically illustrates a configuration of a voice recognition supplementary service providing system according to an embodiment of the present disclosure.

As illustrated in FIG. 1, the system includes a terminal device 100 additionally receiving and displaying screen content as well as voice information during the use of a voice recognition service, an Interactive Voice Response (IVR) device 200 relaying the voice recognition service through a voice call connection of the terminal device 100, a voice recognition device 300 generating and providing voice information and text information corresponding to a designated step according to provision of the voice recognition service of the terminal device, and a screen service device 400 configuring screen content based on the generated text information and providing the screen content to the terminal device 100. The terminal device 100 refers to a smart phone which is equipped with a platform for operating the terminal device, for example, iPhone OS (iOS), Android, Windows Mobile or the like and can access the wireless Internet based on the corresponding platform during a voice call and all phones which can access the wireless Internet during a voice call.

The terminal device 100 accesses the IVR device 200 to make a request for the voice recognition service.

More specifically, after a voice call connection to the IVR device 200, the terminal device 100 makes a request for the voice recognition service based on a service guide provided from the IVR device 200. In connection with this, the IVR device 200 identifies whether the service can be provided to the terminal device 100 through the screen service device 400. As a result, the IVR device 200 identifies that the terminal device 100 corresponds to a terminal device which can access the wireless Internet during the voice call and has a service application for receiving the screen content.

Further, the terminal device 100 executes the installed service application to receive the screen content corresponding to voice information during the use of the voice recognition service.

More specifically, after the request for the voice recognition service, the terminal device 100 executes the installed service application according to reception of a driving message received from the screen service device 400 and accesses the screen service device 400 to receive the screen content provided in addition to the voice information provided from the voice recognition device 300.

Further, the terminal device 100 receives voice information according to the use of the voice recognition service.

More specifically, the terminal device 100 receives the voice information generated by the voice recognition device 300 corresponding to a designated step according to the voice recognition service connection through the IVR device 200. At this time, the voice information received through the IVR device 200 may correspond to, for example, a voice guide providing information on the voice recognition service, a voice suggested word for inducing a voice input of the user, keyword information corresponding to a voice recognition result of the user based on the voice suggested word, a voice query word for identifying a recognition error of the extracted keyword information, a voice suggested word for inducing a re-input of the voice of the user when the recognition error of the extracted keyword information is identified, and a voice guide for a particular content obtained based on the extracted keyword information.

Further, the terminal device 100 may obtain a screen content corresponding to the received voice information.

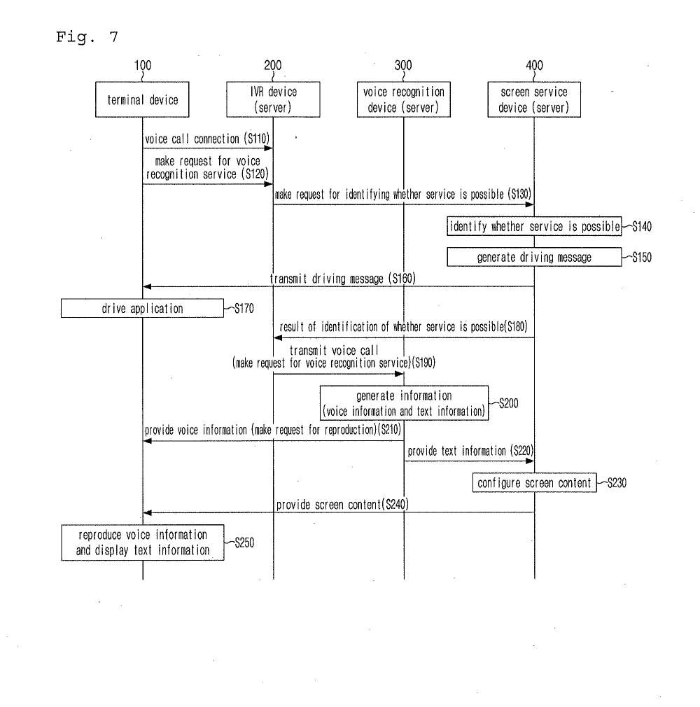

More specifically, the terminal device 100 receives a screen content including text information synchronized with voice information received through the IVR device 200 according to each of the designated steps from the screen service device 400. At this time, as illustrated in FIGS. 5 and 6, the screen content received from the screen service device 400 may include, for example, first text information (a) corresponding to the voice guide providing information on the voice recognition service, second text information (b) corresponding to the voice suggested word for inducing the voice input of the user, third text information (c) corresponding to the keyword information which is the voice recognition result of the user based on the voice suggested word, fourth text information (d) corresponding to the voice query word for identifying the recognition error of the extracted keyword information, fifth text information (e) corresponding to the voice guide of the particular content extracted based on the keyword information, and sixth text information (f) corresponding to the voice suggested word for inducing the re-input of the voice of the user.

Further, the terminal device 100 displays the text information included in the screen content.

More specifically, the terminal device 100 receives voice information reproduced through the IVR device 200 according to each of the designated steps and also displays text information included in the screen content received from the screen service device 300 at the same time. At this time, in order to display text information newly received from the screen service device 400 according to the designated step, the terminal device 100 applies a chatting window scheme of adding and displaying the new text information while maintaining the previously displayed text information as illustrated in FIGS. 5 and 6. That is, the terminal device 100 may allow the user to easily search for a conventional display item through a scroll up and down to improve service understanding by applying a text information display form in the above described chatting widow scheme. Particularly, when transmission time points of voice information transmitted through a circuit network and a screen content transmitted through a packet network are not the same as each other and thus the received voice information and the text information do not match, the terminal device 100 may allow the user to intuitively and easily determine where information corresponding to the currently received voice is displayed on the screen through the scroll up and down.

The voice recognition device 300 generates voice information corresponding to the designated step according to provision of the voice recognition service for the terminal device 100.

More specifically, the voice recognition device 300 receives a voice call for the terminal device 100 from the IVR device 200 and provides the voice recognition service, and generates voice information according to each step designated in this process. At this time, the voice information generated by the voice recognition device 300 may correspond to, for example, the voice guide providing information on the voice recognition service, the voice suggested word for inducing the voice input of the user, the keyword information corresponding to the voice recognition result of the user based on the voice suggested word, the voice query word for identifying the recognition error of the extracted keyword information, the voice suggested word for inducing the re-input of the voice of the user when the recognition error of the extracted keyword information is identified, and the voice guide for a particular content obtained based on the extracted keyword information.

Further, the voice recognition device 300 generates text information corresponding to the voice information generated according to each of the designated steps.

More specifically, when the voice information is generated in the voice recognition service process as described above, the voice recognition device 300 generates text information having the same sentences as those of the generated voice information. At this time, as illustrated in FIGS. 5 and 6, the text information generated by the voice recognition device 300 may include, for example, the first text information (a) corresponding to the voice guide providing information on the voice recognition service, the second text information (b) corresponding to the voice suggested word for inducing the voice input of the user, the third text information (c) corresponding to the keyword information which is the voice recognition result of the user based on the voice suggested word, the fourth text information (d) corresponding to the voice query word for identifying the recognition error of the extracted keyword information, the fifth text information (e) corresponding to the voice guide of the particular content extracted based on the keyword information, and the sixth text information (f) corresponding to the voice suggested word for inducing the re-input of the voice of the user.

Further, the voice recognition device 300 transmits the generated voice information and text information to the terminal device 100.

More specifically, the voice recognition device 300 transmits the voice information generated according to the designated step by the provision of the voice recognition service to the terminal device 100, to the IVR device 200 and makes a request for reproducing the voice information in the terminal device 100. Simultaneously, the voice recognition device 300 provides the generated text information to the screen service device 200 separately from the provision of the voice information and thus allows the screen content including the text information to be transmitted to the terminal device 100. Then, the transmitted text information is synchronized with the corresponding voice information provided to the terminal device 100 and the text information may be continuously displayed, for example, in the charting window scheme. Meanwhile, in order to synchronize the voice information transmitted to the terminal device 100 and the screen content corresponding to the voice information, the voice recognition device 300 may match a reproduction time point of the voice information and a transmission time point of the screen content by transmitting an additional reproduction request for the voice information provided to the IVR device 200 when the voice recognition device 300 receives a transmission completion signal of the screen content from the screen content device 400 after providing the voice information to the IVR device 200. Alternatively, the voice recognition device 300 may match the reproduction time point of the voice information and the transmission time point of the screen content by applying a configuration of simultaneously providing and making a request for reproducing the corresponding voice information to the IVR device 200 after receiving the transmission completion signal of the screen content from the screen content device 400. For reference, if the screen content device 400 directly provides the transmission completion signal for the screen content to the IVR device 200 and the IVR device 200 having received the transmission completion signal reproduces the voice information pre-provided from the voice recognition device 300, it is possible to match the reproduction time point of the voice information and the transmission time point of the screen content.

Accordingly, the voice recognition device 300 may improve the keyword recognition rate by additionally providing the text information (first text information (a) and second text information (b)) as well as the voice information provided in the voice recognition service process to induce the user to make a voice input of an accurate pronunciation. Further, the voice recognition device 300 provides the text information (third text information (c) and fourth text information (d)) for identifying keyword information corresponding to a voice recognition result of the user and transmits a voice recognition state of the corresponding user before content extraction based on the keyword information, so as to show how the user's pronunciation is recognized, thereby inducing the user to recognize an incorrectly recognized section and to accurately pronounce the corresponding section. In addition, when the user cannot make an accurate pronunciation (for example, when the user speaks a dialect or is a foreigner), the voice recognition device 300 may induce the user to re-input a voice by providing a substitutive word of the corresponding service, for example, an Arabic numeral or a substitutive sentence having an easy pronunciation through text information (sixth text information (f)).

The screen service device 400 induces a connection by executing a service application installed within the terminal device 100.

More specifically, when the screen service device 400 receives a request for identifying whether the service can be provided to the terminal device 100 from the IVR device 200 having received a request for the voice recognition service of the terminal device 100, the screen service device 400 determines that the terminal device 100 is a terminal device which can access the wireless Internet during a voice call by searching a database and the terminal device 100 has the service application for receiving screen content. Further, when it is identified that the terminal device 100 can access the wireless Internet during the voice call and has the service application for receiving the screen content, the screen service device 400 generates a driving message for driving the service application installed within the terminal device 100 and transmits the generated driving message to the terminal device 100, so as to induce the connection of the terminal device 100 through the wireless Internet, that is, a packet network.

Further, the screen service device 400 configures the screen content by obtaining text information corresponding to voice information transmitted to the terminal device 100.

More specifically, as the voice recognition service is provided to the terminal device 100, the screen service device 400 receives text information corresponding to voice information generated for each designated step from the voice recognition device 300 and configures the screen content including the text information received from the voice recognition device 300 according to a format designated to the service application installed within the terminal device 100.

Further, the screen service device 400 provides the screen content configured for each designated step to the terminal device 100.

More specifically, the screen service device 400 provides the screen content configured for each designated step to the terminal device 100 in the voice recognition service providing process, so that the text information included in the screen content may be synchronized with the corresponding voice information which the terminal device 100 is receiving and continuously displayed in, for example, the chatting window scheme.

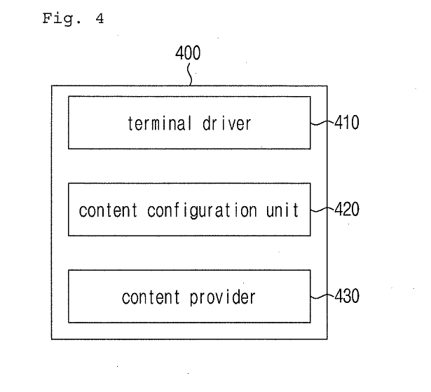

Hereinafter, a more detailed configuration of the terminal device 100 according to an embodiment of the present disclosure will be described with reference to FIG. 2.

That is, the terminal device 100 includes a voice processor 110 for receiving voice information corresponding to a designated step according to the voice recognition service connection and a screen processor 120 for obtaining screen content corresponding to the voice information and displaying text information included in the obtained screen content according to the reception of the corresponding voice information. The screen processor 120 refers to a service application and receives a screen content corresponding to voice information through a packet network connection based on a platform supported by an Operating System (OS).

The voice processor 110 accesses the IVR device 200 to make a request for the voice recognition service.

More specifically, after a voice call connection to the IVR device 200, the voice processor 110 makes a request for the voice recognition service based on a service guide provided from the IVR device 200. In connection with this, the IVR device 200 identifies whether the service can be provided to the terminal device 100 through the screen service device 400. As a result, the IVR device 200 identifies that the terminal device 100 corresponds to a terminal device which can access the wireless Internet during the voice call and has a service application for receiving the screen content.

Further, the voice processor 110 receives voice information according to the use of the voice recognition service.

More specifically, the voice processor 110 receives the voice information generated by the voice recognition device 300 corresponding to a designated step according to the voice recognition service connection through the IVR device 200. At this time, the voice information received through the IVR device 200 may correspond to, for example, a voice guide providing information on the voice recognition service, a voice suggested word for inducing a voice input of the user, keyword information corresponding to a voice recognition result of the user based on the voice suggested word, a voice query word for identifying a recognition error of the extracted keyword information, a voice suggested word for inducing a re-input of the voice of the user when the recognition error of the extracted keyword information is identified, and a voice guide for a particular content obtained based on the extracted keyword information.

The screen processor 120 accesses the screen service device to receive the screen content additionally provided during the voice recognition service using process.

More specifically, after the request for the voice recognition service, the screen processor 120 is invoked according to reception of a driving message transmitted from the screen service device 400 and accesses the screen service device 400 to receive the screen content corresponding to the voice information provided from the voice recognition device 300.

Further, the screen processor 120 obtains the screen content corresponding to the received voice information.

More specifically, the screen processor 120 receives screen content including text information synchronized with voice information received through the IVR device 200 according to each designated step from the screen service device 400. At this time, as illustrated in FIGS. 5 and 6, the screen content received from the screen service device 400 may include, for example, first text information (a) corresponding to the voice guide providing information on the voice recognition service, second text information (b) corresponding to the voice suggested word for inducing the voice input of the user, third text information (c) corresponding to the keyword information which is the voice recognition result of the user based on the voice suggested word, fourth text information (d) corresponding to the voice query word for identifying the recognition error of the extracted keyword information, fifth text information (e) corresponding to the voice guide of the particular content extracted based on the keyword information, and sixth text information (f) corresponding to the voice suggested word for inducing the re-input of the voice of the user.

Further, the screen processor 120 displays the text information included in the screen content.

More specifically, the screen processor 120 receives voice information reproduced through the IVR device 200 according to each designated step and also displays text information included in the screen content received from the screen service device 300 at the same time. At this time, in displaying text information newly received from the screen service device 400 according to the designated step, the screen processor 120 applies the chatting window scheme of adding and displaying the new text information while maintaining the previously displayed text information as illustrated in FIGS. 5 and 6. That is, the screen processor 120 may allow the user to easily search for a conventional display item through a scroll up and down to improve service understanding by applying a text information display form in the above described chatting widow scheme. Particularly, when transmission time points of voice information transmitted through a circuit network and a screen content transmitted through a packet network are not the same as each other and thus the received voice information and the text information do not match, the screen processor 120 may allow the user to intuitively and easily determine where information corresponding to the currently received voice is displayed on the screen through the scroll up and down.

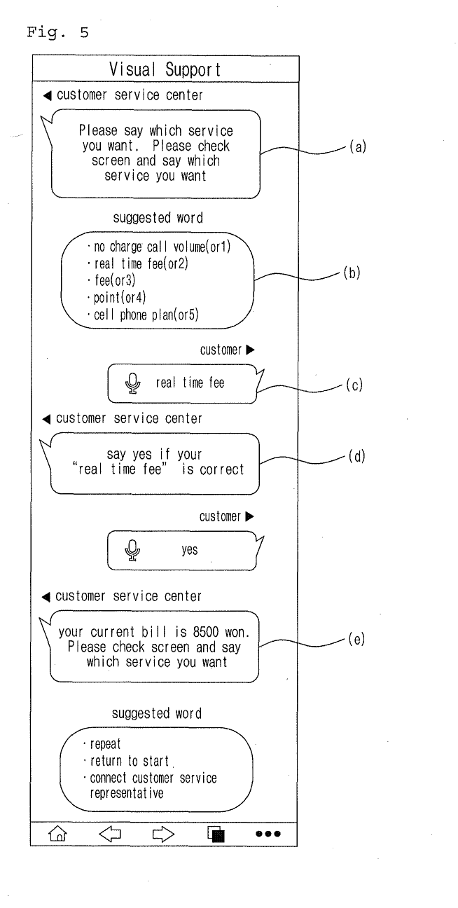

Hereinafter, a more detailed configuration of the voice recognition device 300 according to an embodiment of the present disclosure will be described with reference to FIG. 3.

That is, the voice recognition device 300 includes an information processor 310 for generating voice information and text information corresponding to a designated step according to the provision of the voice recognition service and an information transmitter 320 for transmitting the generated text information to the terminal device 100.

The information processor 310 generates voice information corresponding to the designated step according to the provision of the voice recognition service for the terminal device 100.

More specifically, the information processor 310 receives a voice call for the terminal device 100 from the IVR device 200 and provides the voice recognition service, and generates voice information according to each step designated in this process. At this time, the information processor 310 may generate, for example, the voice guide providing information on the voice recognition service, the voice suggested word for inducing the voice input of the user, the keyword information corresponding to the voice recognition result of the user based on the voice suggested word, the voice query word for identifying the recognition error of the extracted keyword information, the voice suggested word for inducing the re-input of the voice of the user when the recognition error of the extracted keyword information is identified, and the voice guide for a particular content obtained based on the extracted keyword information, according to each designated step.

Further, the information processor 310 generates text information corresponding to the voice information generated according to each designated step.

More specifically, when the voice information is generated in the voice recognition service process as described above, the information processor 310 generates text information having the same sentences as those of the generated voice information. At this time, as illustrated in FIGS. 5 and 6, the screen content received from the information processor 310 may include, for example, first text information (a) corresponding to the voice guide providing information on the voice recognition service, second text information (b) corresponding to the voice suggested word for inducing the voice input of the user, third text information (c) corresponding to the keyword information which is the voice recognition result of the user based on the voice suggested word, fourth text information (d) corresponding to the voice query word for identifying the recognition error of the extracted keyword information, fifth text information (e) corresponding to the voice guide of the particular content extracted based on the keyword information, and sixth text information (f) corresponding to the voice suggested word for inducing re-input of the voice of the user.

Further, the information processor 310 transmits the generated voice information to the terminal device 100.

More specifically, the information processor 310 transmits the voice information generated according to the designated step by the provision of the voice recognition service to the terminal device 100, to the IVR device 200 and makes a request for reproducing the voice information in the terminal device 100, so as to provide the corresponding voice information to the terminal device 100.

Further, the information transmitter 320 transmits the generated text information to the terminal device 100 separately from the provision of the voice information.

More specifically, the information transmitter 320 receives the generated text information corresponding to the voice information from the information processor 310, provides the generated text information to the screen service device 400, and allows the screen content including the text information to be transmitted to the terminal device 100. Then, the transmitted text information is synchronized with the corresponding voice information provided to the terminal device 100 and the text information may be continuously displayed, for example, in the charting window scheme. For example, the information transmitter 320 may improve the keyword recognition rate by additionally providing the text information (first text information (a) and second text information (b)) as well as the voice information provided in the voice recognition service process to induce the user to make a voice input with an accurate pronunciation. Further, the information transmitter 310 provides the text information (third text information (c) and fourth text information (d)) for identifying keyword information corresponding to a voice recognition result of the user and transmits a voice recognition state of the corresponding user before content extraction based on the keyword information, so as to shows how the user's pronunciation is recognized, thereby inducing the user to recognize an incorrectly recognized section and to accurately pronounce the corresponding section. In addition, when the user cannot make an accurate pronunciation (for example, when the user speaks a dialect or is a foreigner), the information transmitter 310 may induce the user to re-input a voice by providing a substitutive word of the corresponding service, for example, an Arabic numeral or a substitutive sentence having an easy pronunciation through text information (sixth text information (f)).

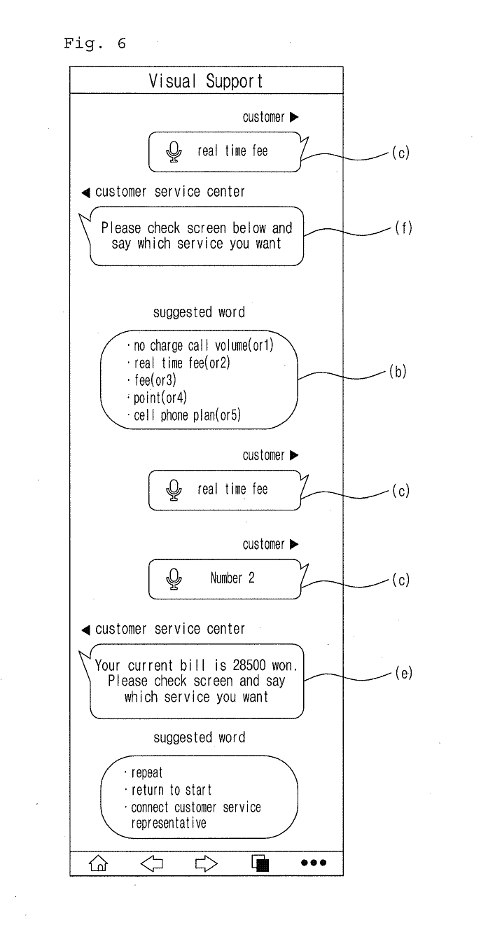

Hereinafter, a more detailed configuration of the screen service device 400 according to an embodiment of the present disclosure will be described with reference to FIG. 4.

That is, the screen service device 400 includes a terminal driver 410 for transmitting a driving message to provide the voice recognition service of the terminal device 100 and driving a service application installed within the terminal device 410; a content configuration unit 420 for obtaining text information corresponding to voice information transmitted to the terminal device 100 according to each designated step by the provision of the voice recognition service and configuring screen content including the obtained text information, and a content provider 430 for providing the configured screen content to the terminal device 100.

The terminal driver 410 induces a connection by executing the service application installed within the terminal device 100.

Preferably, when the terminal driver 410 receives a request for identifying whether the service can be provided to the terminal device 100 from the IVR device 200 having received a request for the voice recognition service of the terminal device 100, the terminal driver 410 determines that the terminal device 100 is a terminal device which can access the wireless Internet during a voice call by searching a database and has the service application for receiving screen content. Further, when it is identified that the terminal device 100 can access the wireless Internet during the voice call and has the service application for receiving the screen content, the terminal driver 410 generates a driving message for driving the service application installed within the terminal device 100 and transmits the generated driving message to the terminal device 100, so as to induce the connection of the terminal device 100 through the wireless Internet, that is, a packet network.

The content configuration unit 420 configures the screen content by obtaining text information corresponding to voice information transmitted to the terminal device 100.

More specifically, the content configuration unit 420 receives text information corresponding to voice information generated according to each designated step from the voice recognition device 300, for example, first text information (a) corresponding to the voice guide providing information on the voice recognition service, second text information (b) corresponding to the voice suggested word for inducing the voice input of the user, third text information (c) corresponding to the keyword information which is the voice recognition result of the user based on the voice suggested word, fourth text information (d) corresponding to the voice query word for identifying the recognition error of the extracted keyword information, fifth text information (e) corresponding to the voice guide of the particular content extracted based on the keyword information, and sixth text information (f) corresponding to the voice suggested word for inducing the re-input of the voice of the user. Further, the screen service device 400 configures the screen content including the text information received from the voice recognition device 300 according to a format designated to the service application installed within the terminal device 100.

The content provider 430 provides the screen content configured according to each designated step to the terminal device 100.

More specifically, the content provider 430 provides the screen content configured according to each designated step in the voice recognition service providing process to the terminal device 100, so that the text information included in the screen content may be synchronized with the corresponding voice information which the terminal device 100 is receiving and continuously displayed in, for example, the chatting window scheme.

As described above, according to the voice recognition supplementary service providing system according to the present disclosure, when the voice recognition service is provided, it is possible to maximally use a service function which cannot be provided through a voice alone by providing a suggested word of the service expected to be used in each situation through a screen, not a voice and providing available functions through the screen. Further, it is possible to improve the keyword recognition rate of the input voice by providing the screen for the service suggested word and available functions and inducing a voice input of the user through the screen recognition. In addition, both a voice guide provided to the user and the keyword input by the user are provided in the chatting window scheme and thus the user can quickly use the service while viewing only the screen without depending on a voice guide, thereby improving understanding and convenience according to the service use.

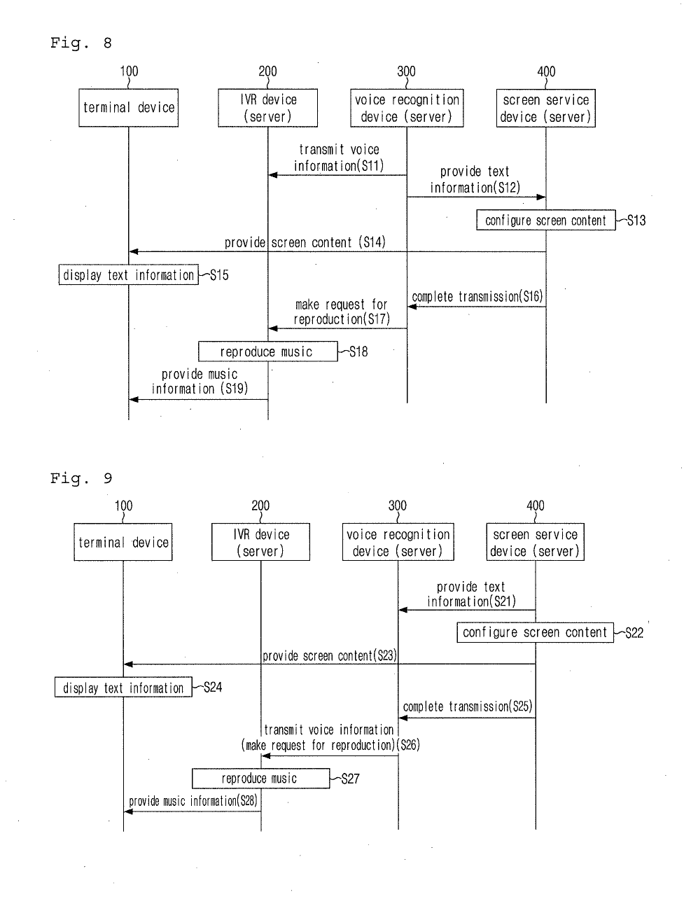

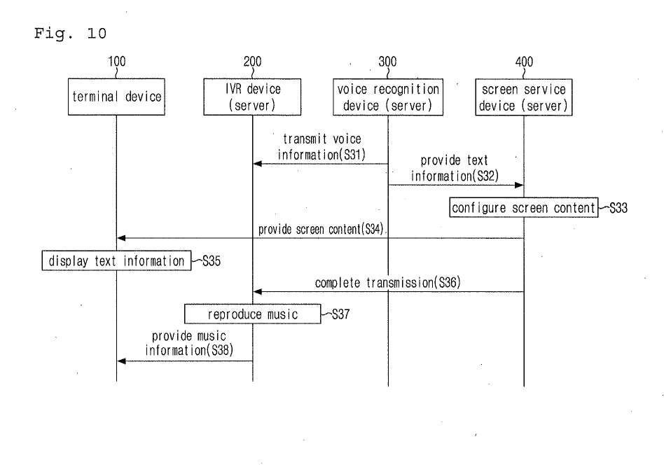

Hereinafter, a voice recognition supplementary service providing method according to an embodiment of the present disclosure will be described with reference to FIGS. 7 to 13. Configurations described in FIGS. 1 to 6 are assigned the same reference numerals for the convenience of description.

First, an operation method of the voice recognition supplementary service providing system according to an embodiment of the present disclosure will be described with reference to FIG. 7.

The terminal device 100 first accesses the IVR device 200 to make a request for the voice recognition service in steps S110 to S120.

Preferably, after a voice call connection to the IVR device 200, the terminal device 100 makes a request for the voice recognition service based on a service guide provided from the IVR device 200.

Then, the screen service device 400 induces a connection by executing a service application installed within the terminal device 100 in steps S130 to S160 and S180.

Preferably, when the screen service device 400 receives a request for identifying whether the service can be provided to the terminal device 100 from the IVR device 200 having received a request for the voice recognition service of the terminal device 100, the screen service device 410 determines that the terminal device 100 is a terminal device which can access the wireless Internet during the voice call by searching a database and has the service application for receiving screen content. Further, when it is identified that the terminal device 100 can access the wireless Internet during the voice call and has the service application for receiving the screen content, the screen service device 400 generates a driving message for driving the service application installed within the terminal device 100 and transmits the generated driving message to the terminal device 100, so as to induce the connection of the terminal device 100 through the wireless Internet, that is, packet network, and then transmits a result of whether the service can be provided to the IVR device 200.

Then, the terminal device 100 executes the installed service application to receive the screen content corresponding to voice information during the use of the voice recognition service in step S170.

Preferably, after the request for the voice recognition service, the terminal device 100 executes the installed service application according to reception of the driving message received from the screen service device 400 and accesses the screen service device 400 to receive the screen content provided in addition to the voice information provided from the voice recognition device 300.

Next, the voice recognition device 300 generates voice information and text information corresponding to the designated step according to provision of the voice recognition service for the terminal device 100 in step S200.

More specifically, the voice recognition device 300 receives a voice call for the terminal device 100 from the IVR device 200 and provides the voice recognition service, and generates voice information according to each step designated in this process. At this time, the voice information generated by the voice recognition device 300 may correspond to, for example, the voice guide providing information on the voice recognition service, the voice suggested word for inducing the voice input of the user, the keyword information corresponding to the voice recognition result of the user based on the voice suggested word, the voice query word for identifying the recognition error of the extracted keyword information, the voice suggested word for inducing the re-input of the voice of the user when the recognition error of the extracted keyword information is identified, and the voice guide for a particular content obtained based on the extracted keyword information. Further, when the voice information is generated in the voice recognition service process as described above, the voice recognition device 300 generates text information having the same sentences as those of the generated voice information. At this time, as illustrated in FIGS. 5 and 6, the text information generated by the voice recognition device 300 may include, for example, the first text information (a) corresponding to the voice guide providing information on the voice recognition service, the second text information (b) corresponding to the voice suggested word for inducing the voice input of the user, the third text information (c) corresponding to the keyword information which is the voice recognition result of the user based on the voice suggested word, the fourth text information (d) corresponding to the voice query word for identifying the recognition error of the extracted keyword information, the fifth text information (e) corresponding to the voice guide of the particular content extracted based on the keyword information, and the sixth text information (f) corresponding to the voice suggested word for inducing the re-input of the voice of the user.

Then, the voice recognition device 300 transmits the generate voice information and text information in steps S210 to S220.

Preferably, the voice recognition device 300 provides the voice information generated according to the designated step by the provision of the voice recognition service to the terminal device 100 to make a request for reproducing the voice information and also provides the generated text information to the screen service device 200 to allow the screen content including the text information to be transmitted to the terminal device 100.

Then, the screen service device 400 configures the screen content by obtaining text information corresponding to the voice information transmitted to the terminal device 100 in step S230.

Preferably, the screen service device 400 receives the text information corresponding to the voice information generated according to each designated step by the provision of the voice recognition service to the terminal device 100 from the voice recognition device 300 and configures the screen content including the text information received from the voice recognition device 300 according to a format designated to the service application installed within the terminal device 100.

Next, the IVR device 200 transmits the voice information to the terminal device 100 and the screen service device 400 provides the screen content to the terminal device 100 in steps S240 to S260.

Preferably, the IVR device 200 allows the voice information transmitted from the voice recognition device 300 to be transmitted to the terminal device 100 through the reproduction of the corresponding voice information and provides the screen content configured according to each designated step in the voice recognition service to the terminal device 100 at the same time.

Thereafter, the terminal device 100 displays the text information included in the screen content in step S270.

More specifically, the terminal device 100 receives the voice information reproduced through the IVR device 200 according to each designated step and also displays the text information included in the screen content received from the screen service device 300 at the same time. At this time, in displaying text information newly received from the screen service device 400 according to the designated step, the terminal device 100 applies a chatting window scheme of adding and displaying the new text information to apply while maintaining the previously displayed text information as illustrated in FIGS. 5 and 6. That is; the terminal device 100 may allow the user to easily search for a conventional display item through a scroll up and down to improve service understanding by applying a text information display form in the above described chatting widow scheme. Particularly, when transmission time points of voice information transmitted through a circuit network and a screen content transmitted through a packet network are not the same as each other and thus the received voice information and the text information do not match, the terminal device 100 may allow the user to intuitively and easily determine where information corresponding to the currently received voice is displayed on the screen through the scroll up and down.

Meanwhile, in transmitting the generated voice information and text information, the voice recognition device 300 may synchronize the voice information transmitted to the terminal device 100 with the screen content corresponding to the voice information.

Preferably, in order to synchronize the voice information transmitted to the terminal device 100 and the screen content corresponding to the voice information, when the voice recognition device 300 receives a transmission completion signal of the screen content from the screen content device 400 after providing the voice information to the IVR device 200 in steps S12 to S16, the voice recognition device 300 may match a reproduction time point of the voice information and a transmission time point of the screen content by transmitting an additional reproduction request for the voice information provided to the IVR device 200 in steps S17 to S19. Further, the voice recognition device 300 may match the reproduction time point of the voice information and the transmission time point of the screen content by simultaneously providing and making a request for reproducing the corresponding voice information to the IVR device 200 after receiving the transmission completion signal of the screen content from the screen content device 400 in steps S26 to S28. In connection with this, as a separate method of matching the reproduction time point of the voice information and the transmission time point of the screen content, the screen content device 400 directly provides the transmission completion signal of the screen content to the IVR device 200 in steps S31 to S36 and the IVR device 200 having received the transmission completion signal reproduces voice information pre-provided from the voice recognition device 300, so as to match the reproduction time point of the voice information and the transmission time point of the screen content as illustrated in FIG. 10.

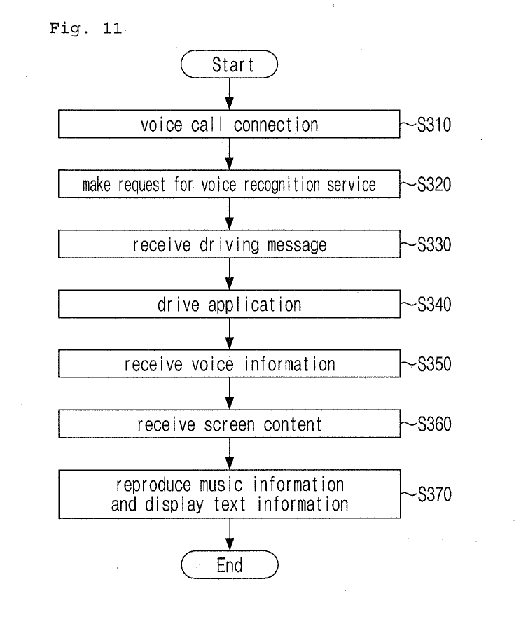

Hereinafter, an operation method of the terminal device 100 according to an embodiment of the present disclosure will be described with reference to FIG. 11.

The terminal device 100 first accesses the IVR device 200 to make a request for the voice recognition service in steps S310 to S320.

Preferably, after a voice call connection to the IVR device 200, the voice processor 110 makes a request for the voice recognition service based on a service guide provided from the IVR device 200. In connection with this, the IVR device 200 identifies whether the service can be provided to the terminal device 100 through the screen service device 400. As a result, the IVR device 200 identifies that the terminal device 100 corresponds to a terminal device which can access the wireless Internet during the voice call and has a service application for receiving the screen content.

Then, the terminal device 100 accesses the screen service device to receive the screen content additionally provided in the voice recognition service using process in steps S330 to S340.

Preferably, after the request for the voice recognition service, the screen processor 120 is invoked according to reception of a driving message transmitted from the screen service device 400 and accesses the screen service device 400 to receive the screen content corresponding to the voice information provided from the voice recognition device 300.

Then, the terminal device 100 receives the voice information according to the use of the voice recognition service in step S350.

Preferably, the voice processor 110 receives the voice information generated by the voice recognition device 300 according to the designated step by the voice recognition service connection through the IVR device 200. At this time, the voice information received through the IVR device 200 may correspond to, for example, a voice guide providing information on the voice recognition service, a voice suggested word for inducing a voice input of the user, keyword information corresponding to a voice recognition result of the user based on the voice suggested word, a voice query word for identifying a recognition error of the extracted keyword information, a voice suggested word for inducing a re-input of the voice of the user when the recognition error of the extracted keyword information is identified, and a voice guide for a particular content obtained based on the extracted keyword information.

Further, the terminal device 100 obtains screen content corresponding to the received voice information in step S360.

Preferably, the screen processor 120 receives screen content including text information synchronized with voice information received through the IVR device 200 according to each designated step from the screen service device 400. At this time, as illustrated in FIGS. 5 and 6, the screen content received from the screen service device 400 may include, for example, first text information (a) corresponding to the voice guide providing information on the voice recognition service, second text information (b) corresponding to the voice suggested word for inducing the voice input of the user, third text information (c) corresponding to the keyword information which is the voice recognition result of the user based on the voice suggested word, fourth text information (d) corresponding to the voice query word for identifying the recognition error of the extracted keyword information, fifth text information (e) corresponding to the voice guide of the particular content extracted based on the keyword information, and sixth text information (f) corresponding to the voice suggested word for inducing the re-input of the voice of the user.

Thereafter, the text information included in the screen content is displayed in step S370.

Preferably, the screen processor 120 receives voice information reproduced through the IVR device 200 according to each designated step and also displays text information included in the screen content received from the screen service device 300 at the same time. At this time, in displaying text information newly received from the screen service device 400 according to the designated step, the screen processor 120 applies the chatting window scheme of adding and displaying the new text information while maintaining the previously displayed text information as illustrated in FIGS. 5 and 6. That is, the screen processor 120 may allow the user to easily search for a conventional display item through a scroll up and down to improve service understanding by applying a text information display form in the above described chatting widow scheme. Particularly, when transmission time points of voice information transmitted through a circuit network and a screen content transmitted through a packet network are not the same as each other and thus the received voice information and the text information do not match, the screen processor 120 may allow the user to intuitively and easily determine where information corresponding to the currently received voice is displayed on the screen through the scroll up and down.

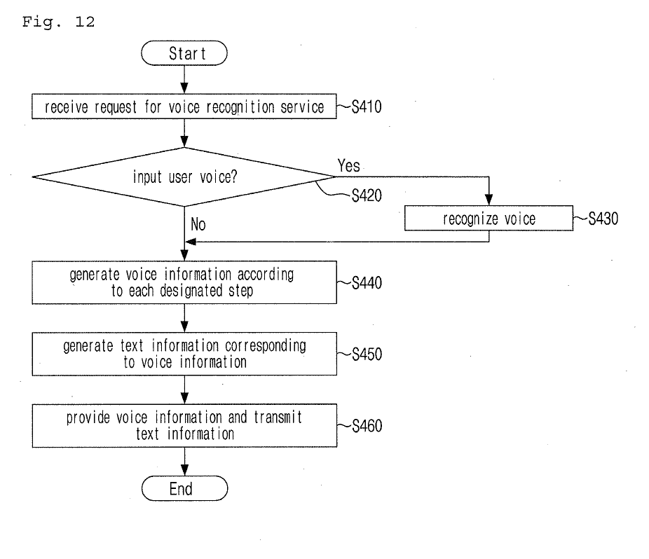

Hereinafter, an operation method of the voice recognition device 300 according to an embodiment of the present disclosure will be described with reference to FIG. 12.

The voice recognition device 300 generates voice information corresponding to the designated step according to the provision of the voice recognition service to the terminal device 100 in steps S410 to S440.

Preferably, the information processor 310 receives a voice call for the terminal device 100 from the IVR device 200 and provides the voice recognition service, and generates voice information according to each step designated in this process. At this time, the information processor 310 may generate a voice guide for guiding the voice recognition service and a voice suggested word for inducing a voice input of the user according to each designated step. Meanwhile, when a voice of the user based on the voice suggested word is input, the information processor 310 may generate, for example, keyword information corresponding to a voice recognition result of the user, a voice query word for identifying a recognition error of the extracted keyword information, a voice suggested word for inducing a voice re-input of the user when the recognition error of the extracted keyword information is identified, and a voice guide of a particular content obtained based on the extracted keyword information.

Then, the text information corresponding to the voice information generated according to each designated step is generated in step S450.

Preferably, when the voice information is generated in the voice recognition service process as described above, the information processor 310 generates text information having the same sentences as those of the generated voice information. At this time, as illustrated in FIGS. 5 and 6, the screen content received from the information processor 310 may include, for example, first text information (a) corresponding to the voice guide providing information on the voice recognition service, second text information (b) corresponding to the voice suggested word for inducing the voice input of the user, third text information (c) corresponding to the keyword information which is the voice recognition result of the user based on the voice suggested word, fourth text information (d) corresponding to the voice query word for identifying the recognition error of the extracted keyword information, fifth text information (e) corresponding to the voice guide of the particular content extracted based on the keyword information, and sixth text information (f) corresponding to the voice suggested word for inducing the re-input of the voice of the user.

Thereafter, the generated voice information and text information are transmitted to the terminal device 100 in step S460.

Preferably, the information processor 310 transmits the voice information generated according to the designated step by the provision of the voice recognition service to the terminal device 100, to the IVR device 200 and makes a request for reproducing the voice information, so as to provide the corresponding voice information to the terminal device 100. Further, the information transmitter 310 receives the generated text information corresponding to the voice information from the information processor 310, provides the generated text information to the screen service device 400, and allows the screen content including the text information to be transmitted to the terminal device 100. Then, the transmitted text information is synchronized with the corresponding voice information provided to the terminal device 100 and the text information may be continuously displayed, for example, in the charting window scheme. For example, the information transmitter 320 may improve the keyword recognition rate by additionally providing the text information (first text information (a) and second text information (b) as well as the voice information provided in the voice recognition service process to induce the user to make a voice input with an accurate pronunciation. Further, the information transmitter 310 provides the text information (third text information (c) and fourth text information (d)) for identifying keyword information corresponding to a voice recognition result of the user and transmits a voice recognition state of the corresponding user before content extraction based on the keyword information, so as to shows how the user's pronunciation is recognized, thereby inducing the user to recognize an incorrectly recognized section and to make an accurate pronunciation in the corresponding section. In addition, when the user cannot accurately pronounce (for example, when the user speaks a dialect or is a foreigner), the information transmitter 310 may induce the user to re-input a voice by providing a substitutive word of the corresponding service, for example, an Arabic numeral or a substitutive sentence having an easy pronunciation through text information (sixth text information (f)).

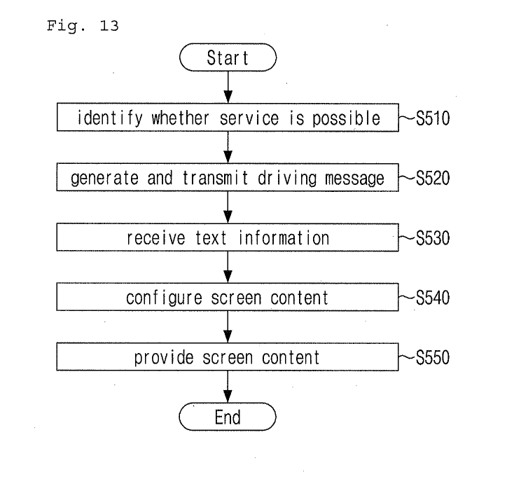

Hereinafter, an operation method of the screen service device 400 according to an embodiment of the present disclosure will be described with reference to FIG. 13.

The screen service device 400 first induces a connection by executing a service application installed within the terminal device 100 in steps S510 to S520.

Preferably, when the terminal driver 410 receives a request for identifying whether the service can be provided to the terminal device 100 from the IVR device 200 having received a request for the voice recognition service of the terminal device 100, the terminal driver 410 determines that the terminal device 100 is a terminal device which can access the wireless Internet during the voice call by searching a database and has the service application for receiving a screen content. Further, when it is identified that the terminal device 100 can access the wireless Internet during the voice call and has the service application for receiving the screen content, the terminal driver 410 generates a driving message for driving the service application installed within the terminal device 100 and transmits the generated driving message to the terminal device 100, so as to induce the connection of the terminal device 100 through the wireless Internet, that is, packet network.

Then, the screen service device 400 configures the screen content by obtaining text information corresponding to voice information transmitted to the terminal device 100 in steps S530 to S540.

Preferably, the content configuration unit 420 receives text information corresponding to voice information generated according to each designated step from the voice recognition device 300, for example, first text information (a) corresponding to the voice guide providing information on the voice recognition service, second text information (b) corresponding to the voice suggested word for inducing the voice input of the user, third text information (c) corresponding to the keyword information which is the voice recognition result of the user based on the voice suggested word, fourth text information (d) corresponding to the voice query word for identifying the recognition error of the extracted keyword information, fifth text information (e) corresponding to the voice guide of the particular content extracted based on the keyword information, and sixth text information (f) corresponding to the voice suggested word for inducing the re-input of the voice of the user. Further, the screen service device 400 configures the screen content including the text information received from the voice recognition device 300 according to a format designated to the service application installed within the terminal device 100.

Thereafter, the screen content configured according to each designated step is provided to the terminal device 100 in step S550.

Preferably, the content provider 430 provides the screen content configured according to each designated step in the voice recognition service providing process to the terminal device 100, so that the text information included in the screen content may be synchronized with the corresponding voice information which the terminal device 100 is receiving and continuously displayed in, for example, the chatting window scheme.

As described above, according to the voice recognition supplementary service providing method according to the present disclosure, it is possible to maximally use a service function which cannot be provided through a voice alone by providing a suggested word of the service expected to be used in each situation through a screen rather than a voice, and providing available functions through the screen. Further, it is possible to improve the keyword recognition rate of the input voice by providing the screen for the service suggested word and available functions and inducing a voice input of the user through the screen recognition. In addition, both a voice guide provided to the user and the keyword input by the user are provided in the chatting window scheme and thus the user can quickly use the service while viewing only the screen without depending on a voice guide, thereby improving understanding and convenience according to the service use.

Meanwhile, the method described in connection with the provided embodiments or steps of the algorithm may be implemented in a form of a program command, which can be executed through various computer means, and recorded in a computer-readable recording medium. The computer-readable medium may include a program command, a data file, and a data structure individually or a combination thereof. The program command recorded in the medium is specially designed and configured for the present disclosure, but may be used after being known to those skilled in computer software fields. Examples of the computer-readable recording medium include magnetic media such as hard disks, floppy disks and magnetic tapes, optical media such as a Compact Disc Read-Only Memory (CD-ROM) and a Digital Versatile Disc (DVD), magneto-optical media such as floppy disks, and hardware devices such as a Read-Only Memory (ROM), a Random Access Memory (RAM) and a flash memory, which are specially configured to store and perform program instructions. Examples of the program command include a machine language code generated by a compiler and a high-level language code executable by a computer through an interpreter and the like. The hardware devices may be configured to operate as one or more software modules to perform the operations of the present disclosure, and vice versa.

Although the present disclosure has been described in detail with reference to exemplary embodiments, the present disclosure is not limited thereto and it is apparent to those skilled in the art that various modifications and changes can be made thereto without departing from the scope of the present disclosure.

### INDUSTRIAL APPLICABILITY

According to a voice recognition supplementary service providing method and an apparatus applied to the same according to the present disclosure, in that the present disclosure induces a user to input a voice through the provision of a screen containing a suggested word corresponding to a service and available functions expected to be used in each situation in connection with a voice recognition service and sequentially provides both a voice guide provided to the user and a keyword input by the user in a chatting window scheme, related technologies of the present disclosure can be used and also the device to which the present disclosure is applied has a high probability of entering into the market and being sold. Therefore, the present disclosure can be obviously implemented in reality and thus is highly applicable to the industries.

1. A screen service device comprising:
a terminal driver for transmitting a driving message to provide a voice recognition service to a terminal device and driving a service application installed within the terminal device;
a content configuration unit for obtaining text information corresponding to voice information transmitted to the terminal device according to each designated step by the provision of the voice recognition service and configuring screen content including the obtained text information according to a format designated to the service application; and
a content provider for providing the screen content configured according to said each designated step to the terminal device and continuously displaying text information included in the screen content such that the text information is synchronized with corresponding voice information transmitted to the terminal device.

2. A voice recognition device comprising:
an information processor for generating voice information corresponding to each designated step by a provision of a voice recognition service to a terminal device, providing the generated voice information to the terminal device, and generating text information corresponding to the generated voice information; and
an information transmitter for transmitting the text information generated according to said each designated step to the terminal device and continuously displaying the transmitted text information such that the text information is synchronized with the corresponding voice information provided to the terminal device.

3. The voice recognition device of claim 2, wherein the information processor simultaneously generates text information and voice information corresponding to at least one of a voice guide providing information on the voice recognition service and a voice suggested word for inducing a voice input of a user.

4. The voice recognition device of claim 3, wherein, when a voice of a user based on the voice suggested word is transmitted from the terminal device, the information processor extracts keyword information corresponding to a voice recognition result and generates text information corresponding to the extracted keyword information.

5. The voice recognition device of claim 4, wherein the information processor simultaneously generates the voice information and the text information corresponding to a voice query word for identifying a recognition error of the extracted keyword information.

6. The voice recognition device of claim 4, wherein, when the recognition error of the extracted keyword information is identified, the information processor simultaneously generates voice information and text information corresponding to a voice suggested word for inducing the user to make a re-input.

7. The voice recognition device of claim 4, wherein the information processor obtains a particular content based on the extracted keyword information and generates voice information and text information corresponding to the obtained particular content.

8. The voice recognition device of claim 2, wherein, when a transmission time point when the text information is transmitted to the terminal device is identified, the information processor provides the voice information to the terminal device according to the identified transmission time point or transmits a separate request for reproducing the voice information pre-provided.

9. A terminal device comprising:
a voice processor for receiving voice information corresponding to a designated step by a connection of a voice recognition service; and
a screen processor for obtaining screen content including text information synchronized with the voice information received according to each designated step and displaying the text information included in the screen content according to the reception of the voice information.

10. The terminal device of claim 9, wherein, when new text information is obtained according to the designated step, the screen processor adds and displays the new text information while maintaining the previously displayed text information.

11. A method of operating a screen service device, the method comprising:
driving a service application installed within a terminal device by transmitting a driving message to provide a voice recognition service to the terminal device and;
obtaining text information corresponding to voice information transmitted to the terminal device according to each designated step by the provision of the voice recognition service;
configuring screen content including the obtained text information according to a format designated to the service application; and
providing the screen content configured according to said each designated step to the terminal device and continuously displaying the text information included in the content screen such that the text information is synchronized with the corresponding voice information transmitted to the terminal device.

12. A method of operating a voice recognition device, the method comprising:
generating voice information corresponding to a designated step by a provision of a voice recognition service to a terminal device and text information corresponding to the voice information;
providing the voice information generated according to the designated step to the terminal device; and
transmitting the generated text information to the terminal device simultaneously with the provision of the voice information and continuously displaying the transmitted text information such that the text information is synchronized with the corresponding voice information provided to the terminal device.

13. The method of claim 12, wherein the generating of the voice information comprises simultaneously generating text information and voice information corresponding to at least one of a voice guide for providing information on the voice recognition service and a voice suggested word for inducing a voice input of a user.

14. The method of claim 13, wherein, when a voice of a user based on the voice suggested word is transmitted from the terminal device, the generating of the voice information comprises:
extracting keyword information corresponding to a voice recognition result; and
generating text information corresponding to the extracted keyword information.

15. The method of claim 14, wherein the generating of the voice information comprises simultaneously generating the voice information and the text information corresponding to a voice query word for identifying a recognition error of the extracted keyword information.

16. The method of claim 14, wherein, when the recognition error of the extracted keyword information is identified, the generating of the voice information comprises simultaneously generating voice information and text information corresponding to a voice suggested word for inducing the user to make a re-input.

17. The method of claim 14, wherein the generating of the voice information comprises obtaining a particular content based on the extracted keyword information and generating voice information and text information corresponding to the obtained particular content.

18. The method of claim 12, wherein the providing of the voice information comprises:
identifying a transmission time point when the text information is transmitted to the terminal device; and
providing the voice information according to the identified transmission time point to the terminal device to make a request for reproducing the voice information or transmitting a separate request for reproducing the voice information pre-provided.

19. A method of operating a terminal device, the method comprising:
receiving voice information corresponding to a designated step by a connection of a voice recognition service;
obtaining screen content including text information synchronized with voice information received according to each designated step; and
displaying the text information included in the screen content according to the reception of the voice information.

20. The method of claim 19, wherein, when new text information is obtained according to the designated step, the displaying of the text information comprises adding and displaying the new text information while maintaining the previously displayed text information.

21. A computer-readable recording medium comprising a command for executing the steps of:
receiving voice information corresponding to a designated step by a connection of a voice recognition service;
obtaining screen content including text information synchronized with voice information received according to each designated step; and
displaying the text information included in the screen content according to the reception of the voice information.

22. The computer-readable recording medium of claim 21, wherein, when new text information is obtained according to the designated step, the displaying of the text information comprises adding and displaying the new text information while maintaining the previously displayed text information.
